(19) United States
(12) Patent Application Publication
(10) Pub. No.: US 2026/0094455 A1
(43) Pub. Date: Apr. 2, 2026

(54) AUTOMATED VEHICLE IDENTIFICATION AND QUEUE MANAGEMENT SYSTEM FOR PICKUP OF PERSONS

(71) Applicant: Nicholas Demes Owens, SARASOTA, FL (US)

(72) Inventor: Nicholas Demes Owens, SARASOTA, FL (US)

(21) Appl. No.: 18/902,776

(22) Filed: Sep. 30, 2024

(51) Int. Cl. G06V 20/62; G06F 3/04817; G06T 13/80; G06V 30/10; H04R 27/00

(52) U.S. Cl. CPC G06V 20/625; G06F 3/04817; G06T 13/80; G06V 30/10; H04R 27/00

(57) ABSTRACT

An automated vehicle identification and queue management system and method for efficient and secure person pickup is disclosed. The system comprises detection devices for identifying vehicles in a designated area, a server for processing vehicle data, generating a pickup queue, and a user interface device for displaying queue information. The method includes detecting and identifying vehicles, associating vehicles with a driver and person(s) to be picked up, and generating a pickup queue. The system transmits vehicle data to the user interface, which displays a visual representation of the queue using icons. These icons are updated in real-time to reflect current vehicle status and position. The invention can use various detection methods including optical character recognition for license plate reading or proximity sensors for vehicle detection. It includes features for database integration, audible announcements, and security alerts, providing a comprehensive solution for managing person pickup in various institutional settings.

### FIELD OF INVENTION

This invention relates to the field of vehicle identification and queue management technological systems, specifically focusing on person dismissal and pickup processes. Some aspects of the invention encompass automated vehicle identification, person-vehicle matching, and queue management technologies, while other aspects integrate computer vision, real-time data processing, and mobile communication to streamline the often chaotic process of student pickup at schools, camps, recreational centers and other childcare facilities.

### BACKGROUND OF THE INVENTION

The process of student pickup at schools and childcare facilities has long been a source of frustration and concern for parents, guardians, and educational institutions alike. The traditional methods of managing student dismissal and pickup are often inefficient, time-consuming, and potentially unsafe, creating a daily logistical challenge for many schools. Long queues of vehicles, extended wait times, and the difficulty of accurately matching students with the correct vehicles not only cause inconvenience but also raise significant safety and security concerns. The core issues plaguing current pickup systems include inefficiency resulting in traffic congestion around school premises, safety concerns related to releasing students to unauthorized individuals, resource-intensive processes requiring multiple staff members, lack of real-time information for parents and staff, and the environmental impact from vehicles idling in long queues.

The state of the art in student pickup management varies in sophistication but generally falls short of addressing all key issues comprehensively. Many schools still rely on manual systems where staff members physically identify vehicles and call students, often using handheld radios or intercoms. This method is prone to human error and highly dependent on staff familiarity with families. Some institutions have implemented number display systems, issuing numbers to families which are displayed on vehicles, with staff calling numbers in sequence. While this improves organization, it still requires significant manual intervention and doesn't fully address safety concerns. More advanced solutions utilize RFID tag systems on student backpacks or parent vehicles which can automate identification but often lack the flexibility to handle exceptions or changes in pickup arrangements. Some schools have adopted mobile applications that allow parents to “check in” when they arrive, but these systems often rely on manual verification and can be cumbersome or even illegal for parents to use while driving.

Recent developments in the industry have been driven by advancements in technology and an increasing focus on school safety and efficiency. There has been a growing recognition of the need for comprehensive, automated solutions that can handle the complexities of modern family structures and varying pickup arrangements. The integration of artificial intelligence and machine learning into school management systems has opened up new possibilities for predictive scheduling and adaptive queue management. Additionally, the widespread adoption of smartphones and tablets has created opportunities for more sophisticated mobile interfaces for both staff and parents.

The relevance of key technologies used in the invention cannot be overstated. Computer vision and object recognition technologies have matured significantly, allowing for reliable automated vehicle identification without the need for special tags or markers. This advancement enables a more flexible and user-friendly system that can adapt to changing vehicles or pickup arrangements without requiring parents to register new information constantly. The ubiquity of high-speed internet and cloud computing has made it possible to process complex data in real-time, enabling instant updates and communications between the system, staff, and parents. Moreover, advancements in user interface design and mobile app development have made it feasible to create intuitive, easy-to-use interfaces for both staff managing the pickup process and parents waiting in vehicles.

The object of the invention is to address the aforementioned challenges by providing a comprehensive, technologically advanced system for managing student pickup processes. The invention aims to significantly improve efficiency by automating vehicle identification and child matching, thereby reducing wait times and traffic congestion. It seeks to enhance safety by ensuring that children are only released to authorized individuals with real-time tracking and notification systems. The invention is designed to reduce the resource burden on schools by minimizing the number of staff required to manage the pickup process and eliminating the need for staff to memorize vehicle-student associations. By providing real-time updates and communication channels, the system aims to keep parents informed and reduce anxiety associated with the pickup process. Additionally, the invention seeks to contribute to environmental sustainability by reducing vehicle idling time through more efficient queue management.

Furthermore, the invention aims to be highly adaptable and scalable, capable of integration with existing school management systems and accommodating a wide range of sizes and configurations of facilities. It is designed with flexibility in mind, allowing for easy updates and modifications to handle changing family structures, custody arrangements, and special circumstances that may arise. The system also aims to provide valuable data insights to school administrators, enabling them to optimize their pickup processes over time and make informed decisions about resource allocation and scheduling.

In summary, the background of this invention is rooted in the pressing need for a more efficient, safe, and user-friendly child pickup system. It builds upon existing technologies and industry developments, leveraging advancements in computer vision, cloud computing, and mobile technology to create a comprehensive solution. The invention seeks to transform the often chaotic and stressful experience of student pickup into a smooth, secure, and efficient process, benefiting students, parents, and educational institutions alike. By addressing the multifaceted challenges of child pickup, this invention aims to set a new standard in school operations management, contributing to improved safety, reduced environmental impact, and enhanced quality of life for all stakeholders involved in the daily ritual of student dismissal and pickup.

### SUMMARY OF THE INVENTION

Embodiments of the present disclosure may include an automated person pickup system including at least one detection device selected from the group consisting of an imaging device and a proximity sensor, configured to detect vehicles in a designated area. Embodiments may also include a server coupled to the detection device, the server including a processor and a memory storing instructions that, when executed by the processor, cause the system to identify vehicles based on data from the detection device.

Embodiments may also include determine an order of the identified vehicles. Embodiments may also include associate each identified vehicle with one or more authorized individuals for pickup. Embodiments may also include generate a pickup queue based on the determined order and associated individuals. Embodiments may also include a user interface device coupled to the server and configured to display the pickup queue and receive user input. Embodiments may also include an output device coupled to the server and configured to communicate pickup instructions.

In some embodiments, the detection device may be an imaging device including a camera with optical character recognition capabilities for reading license plates. In some embodiments, the detection device may be a proximity sensor configured to detect the presence and location of vehicles in the designated area. In some embodiments, the system may include a database storing vehicle information and associated authorized individual information. In some embodiments, the server may be configured to access the database to associate identified vehicles with authorized individuals.

In some embodiments, the user interface device may be a mobile device capable of wireless communication with the server. In some embodiments, the output device may be a public address system configured to announce pickup instructions audibly. In some embodiments, the server may be further configured to update the pickup queue in real-time based on vehicle arrivals and departures detected by the detection device.

In some embodiments, the server may be further configured to generate alerts for unauthorized vehicle detection or security concerns. In some embodiments, the server may be further configured to transmit vehicle identification data, queue position data, and status information for each vehicle in the pickup queue to the user interface device. In some embodiments, the user interface device may be further configured to receive the vehicle identification data, queue position data, and status information from the server.

Embodiments may also include generate animated icons representing the identified vehicles based on the received data. Embodiments may also include create a visual representation of the pickup queue using the generated animated icons. Embodiments may also include display the visual representation of the pickup queue on the user interface device. Embodiments may also include update the animated icons in real-time based on subsequent data received from the server to reflect the current status and position of each vehicle in the queue.

Embodiments may also include identifying the detected vehicles using optical character recognition to read license plates of the vehicles. Embodiments may also include sensing the presence and location of vehicles using a proximity sensor. Embodiments may also include associating each identified vehicle with one or more authorized individuals may include accessing a database storing vehicle information and associated authorized individual information.

Embodiments may also include displaying the visual representation of the pickup queue using generating animated icons representing the identified vehicles based on the received vehicle identification data, queue position data, and status information. Embodiments may also include creating the visual representation of the pickup queue using the generated animated icons. Embodiments may also include updating the animated icons in real-time based on subsequently received data to reflect the current status and position of each vehicle in the queue. Embodiments may also include communicating pickup instructions by announcing the instructions audibly through a public address system.

Embodiments of the present disclosure may also include a method for automated person pickup including detecting vehicles in a designated area using at least one detection device selected from the group consisting of an imaging device and a proximity sensor. Embodiments may also include identifying the detected vehicles based on data from the detection device(s).

Embodiments may also include determining an order of the identified vehicles. Embodiments may also include associating each identified vehicle with one or more authorized individuals for pickup. Embodiments may also include generating a pickup queue based on the determined order and associated individuals. Embodiments may also include transmitting vehicle identification data, queue position data, and status information for each vehicle in the pickup queue to a user interface device. Embodiments may also include displaying a visual representation of the pickup queue on the user interface device. Embodiments may also include communicating pickup instructions as visual representation on the user interface device.

Embodiments of the present disclosure may also include a non-transitory computer-readable storage medium having computer-executable instructions stored thereon that, when executed by one or more processors, cause the one or more processors to perform a method for automated person pickup, the method including detecting vehicles in a designated area using at least one detection device selected from the group consisting of an imaging device and a proximity sensor.

Embodiments may also include identifying the detected vehicles based on data from the detection device(s). Embodiments may also include determining an order of the identified vehicles. Embodiments may also include associating each identified vehicle with one or more authorized individuals for pickup. Embodiments may also include generating a pickup queue based on the determined order and associated individuals.

Embodiments may also include transmitting vehicle identification data, queue position data, and status information for each vehicle in the pickup queue to a user interface device. Embodiments may also include displaying a visual representation of the pickup queue on the user interface device. Embodiments may also include communicating pickup instructions as visual representation on the user interface device.

Embodiments may also include identifying the detected vehicles using optical character recognition to read license plates of the vehicles. Embodiments may also include associating each identified vehicle with one or more drivers and one or more children for pickup. Embodiments may also include accessing a database storing vehicle information and associated authorized individual information.

Embodiments may also include displaying the visual representation of the pickup queue and generating animated icons to represent the identified vehicles based on the received vehicle identification data, queue position data, and status information. Embodiments may also include creating the visual representation of the pickup queue using the generated animated icons. Embodiments may also include updating the animated icons in real-time based on subsequently received data to reflect the current status and position of each vehicle in the queue. In some embodiments, the method may include communicating pickup instructions audibly through a public address system in addition to the visual representation on the user interface device.

### BRIEF DESCRIPTION OF THE DRAWINGS

The novel features believed to be characteristic of the illustrative embodiments are set forth in the appended claims. The illustrative embodiments, as well as a preferred mode of use, will best be understood by reference to the following detailed description when read in conjunction with the accompanying drawings, wherein:

FIG. 1 illustrates a prior art method for person pickup according to one embodiment.

FIG. 2 illustrates a block diagram of an automated person pickup system according to one embodiment.

FIG. 3 is an automated person pickup system according to one exemplary aspect.

FIG. 4 is an illustration of the graphical user interface according to one aspect.

FIG. 5 illustrates a flow diagram process for an automated child/person pickup system according to one aspect.

FIG. 6 is a flowchart that further describes a method for automated person pickup, according to some embodiments of the present disclosure.

### DETAILED DESCRIPTION OF PREFERRED EMBODIMENTS

It is to be understood that the form of the invention shown and described herein is to be taken as a preferred embodiment of the present invention. However, it does not express the full technical spirit and scope of this invention. Accordingly, it should be understood that various changes and modifications may be made to the invention without departing from its spirit and scope.

The present disclosure describes an automated person pickup system enabling efficient and secure management of pickup processes in various institutional settings. Embodiments of the system and method may be physically implemented leveraging computerized automation for elements of vehicle detection, person tracking, and queue management. Alternatively, the system format could flexibly facilitate predominantly in-person, real-life rollout within institutional guidelines while still utilizing key technological components.

In general, the automated person pickup system comprises a network of one or more detection devices, a central processing server, and user interface devices that work together to streamline the pickup process. The system encourages broad applicability across many types of institutions by providing flexible detection methods and customizable queue management. The integration of advanced technologies provides significant incentives for institutions to adopt this system, improving efficiency and safety.

Secure digital tracking of vehicles and person enables oversight and continuity across various stages of the pickup process, spanning from vehicle detection to person pickup. Standardization of key operational parameters, such as automatic queue updates and real-time communication, creates fair and efficient processes across different institutional settings. Optimal configurations for the system structure are determinable through simulation modeling and variables analysis.

The detailed description provided hereafter explores the system architecture, modules, and information flows facilitating the operation of the automated person pickup system in accordance with the phases of the disclosed format. Both hardware implementations and software components are discussed, highlighting the system's versatility and adaptability to various institutional needs.

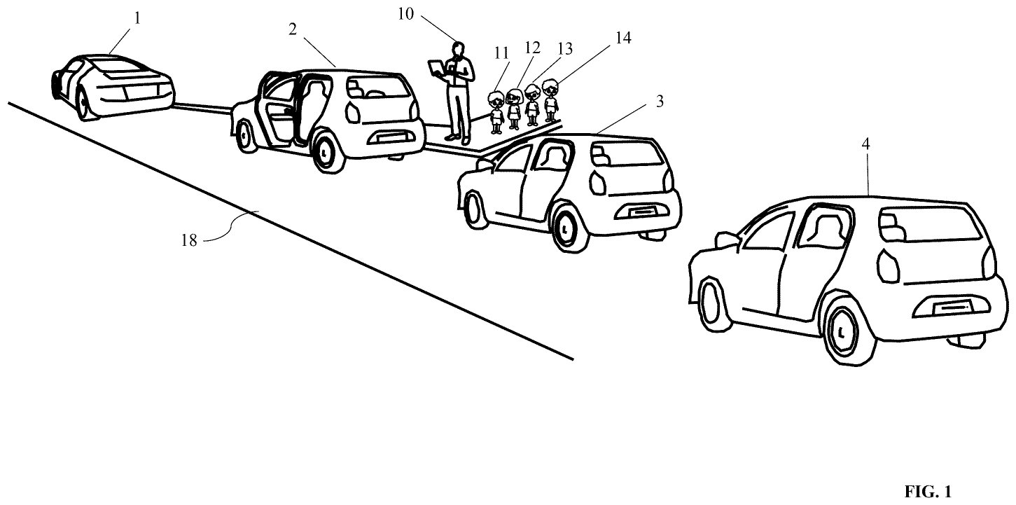

The embodiment of FIG. 1 illustrates a prior art method for person pickup, specifically depicting a child pickup system at an educational institution. The figure shows a designated pickup area 18 where the pickup process occurs, typically a portion of the school's parking lot or a dedicated pickup lane. Within this area, a queue of vehicles is visible, with the first car labeled as 1, followed by the second 2, third 3, and fourth 4 cars, representing their arrival order. Close to the vehicle queue is a line of children waiting to be picked up, labeled as first child 11, second child 12, third child 13, and fourth child 14. Central to this prior art method is a staff member 10 positioned between the vehicle and child queues. The staff member may be an operator responsible for several critical tasks, including vehicle identification, child-vehicle matching, traffic management, safety oversight, and communication with drivers and children. The figure effectively highlights the limitations of this traditional approach, such as its reliance on human memory, limited scalability, potential for errors, lack of real-time updates, inefficiency, resource intensiveness, and limited information access for waiting parents. These drawbacks are particularly evident when dealing with large numbers of students or vehicles, unfamiliar pickup scenarios, or when changes occur in the usual routine.

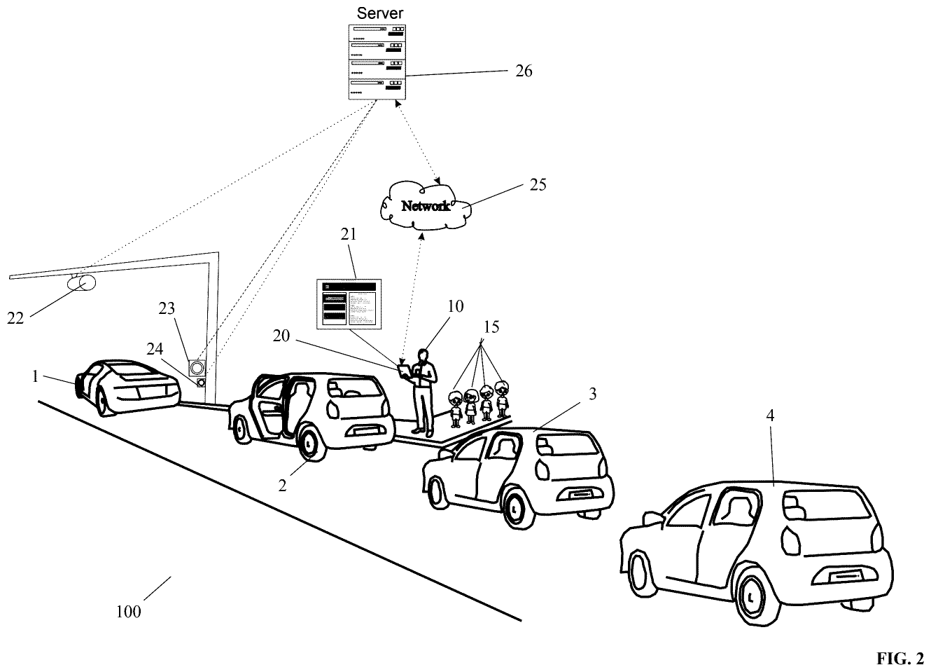

On the other hand, the embodiment of FIG. 2 illustrates a block diagram of an automated person pickup system 100, embodying a significant advancement over traditional pickup methods. This system integrates various technological components to streamline the person pickup process, addressing the limitations of manual systems while providing a scalable and adaptable solution for diverse institutional settings.

Illustrated as comprised in the system is a server 26, which serves as the central processing unit for the entire operation. This server may be equipped with a processor and memory storing instructions that, when executed, enable the system to perform its core functions. The server 26 may be responsible for processing data from various detection devices, identifying vehicles, determining their order, and associating each vehicle with one or more authorized individuals for pickup. It may generate and continuously update the pickup queue based on this information, ensuring real-time accuracy in the pickup process.

The server 26 may be connected to all other components of the system through a network 25. This network facilitates real-time or batched data exchange and system-wide coordination, allowing for seamless communication between different parts of the system. The network 25 could be implemented using various technologies, such as Wi-Fi, Ethernet, or cellular data connections, depending on the specific requirements and constraints of the installation environment.

In the designated pickup area, the system manages a queue of vehicles, represented in the diagram by the first car 1, second car 2, third car 3, and fourth car 4. These vehicles are detected and identified using one or a combination of detection devices, primarily a camera 23 and other sensors 24. The camera 23 serves as an imaging device, capable of capturing high-quality images of the vehicles in the pickup area. This camera may employ advanced imaging technology, potentially including optical character recognition capabilities for reading license plates. The ability to read license plates automatically is a crucial feature, as it allows the system to identify vehicles without requiring any special tags or modifications to the vehicles themselves.

Alternatively or complementing the camera 23 are other sensors 24, which could include proximity sensors, motion detectors, or other types of sensors configured to detect the presence and location of vehicles in the designated area. These sensors may provide additional data points to the system, enhancing its ability to accurately track vehicle movements and positions. A combination of camera and sensors may ensure robust vehicle detection and identification, even in varying environmental conditions or when dealing with a high volume of vehicles.

The children awaiting pickup are collectively represented as 15 in the diagram. Unlike traditional methods where children might be required to line up in a specific order, this automated system allows for more flexibility. The children can wait in a designated area without needing to maintain a particular order, as the system manages the matching process automatically. This not only improves the comfort and safety of the waiting children and allows for more efficient use of space in the pickup area, but also allows for the majority of children to wait behind closed doors inside the facility until a vehicle authorized for pickup is near the operator 10. While current systems need all children to remain outside and nearby the operator to speed up the queue, the new system knows the order of vehicles, which allows for speed combined with the security of keeping most children inside the facility until called for.

Overseeing the entire process is a staff member 10. However, the role of this staff member or operator has evolved significantly from traditional pickup methods. Instead of manually managing every aspect of the pickup process, the staff member now interacts with an operator device 20. This device serves as the primary interface between the human operator and the automated system. In some aspect, in a traditional system, information typically originates from a teacher or administrator and must pass through multiple intermediaries before reaching the staff member responsible for the actual pickup process. This multi-step relay method is inherently flawed, susceptible to miscommunication, information loss, or human error at each transfer point. Moreover, there's a considerable risk that the final recipient might forget or misinterpret the relayed information, potentially leading to serious consequences. The disclosed system eliminates these risks by implementing a centralized, digital information management solution.

In some aspects, authorized person, such as teachers or administrators, can input important information directly into the system. This could include special instructions, behavioral notes, medication reminders, or critical updates about pickup authorization. Further, once information is entered into the system, it becomes immediately visible to all authorized users. This ensures that everyone with system access, from administrators to pickup staff, is instantly aware of the latest updates. Moreover, critical information, such as pickup restrictions due to custody orders, may be prominently displayed on a system interface.

The operator device 20 may be equipped with a graphical user interface (GUI 21, which displays the pickup queue and allows the operator to input data or make adjustments as needed. The GUI 21 presents information in an intuitive and easily understandable format, typically including animated icons representing the identified vehicles. These animated icons create a visual representation of the pickup queue, allowing the staff member to quickly assess the current state of the pickup process.

The operator device 20 receives real-time updates from the server 26, including vehicle identification data, queue position data, and status information for each vehicle in the pickup queue. The GUI 21 may be configured to generate animated icons representing the identified vehicles based on this received data. It may create a visual representation of the pickup queue using these generated animated icons and displays this representation on the screen. Importantly, the GUI 21 may also be capable of updating these animated icons in real-time based on subsequent data received from the server, ensuring that the display always reflects the current status and position of each vehicle in the queue. In further aspects, alert mechanisms may be designed to enhance security and safety beyond the standard pickup procedures, for instance to detect and identify unknown or suspicious vehicles entering the facility grounds, to recognize potentially dangerous items, such as weapons, associated with incoming vehicles, to flag vehicles arriving at non-standard times or accessing restricted areas of the facility, or even to generate and transmit immediate alerts to designated staff members at the facility or parent organization upon detection of any of the above conditions. Preferably, this notification module operates independently of the regular child pickup process, continuously monitoring all vehicle activity within the facility's premises. It utilizes the system's existing camera and sensor network, augmented with specialized image recognition algorithms trained to identify suspicious objects or behaviors.

To facilitate clear communication with both drivers and children, the system may include a public address system 22. This audio output device may be coupled to the server and configured to communicate pickup instructions audibly when necessary. The public address system 22 may work in tandem with the visual information provided on the operator device 20, ensuring that instructions can be conveyed effectively even in noisy or visually obstructed environments.

Another aspect of the system's functionality is its ability to associate each identified vehicle with one or more authorized individuals for pickup. To achieve this, the system may incorporate a database (not explicitly shown in the diagram storing vehicle information and associated authorized individual information. The server 26 may be configured to access this database to make the necessary associations. This feature ensures that children are only released to authorized individuals, significantly enhancing the safety and security of the pickup process.

The automated person pickup system 100 may be designed to operate in real-time, with the server 26 continuously updating the pickup queue based on vehicle arrivals, departures detected by the camera 23 and other sensors 24, as well as input from the staff member 10, such as when children have been marked as picked up. This real-time operation ensures that the system can adapt quickly to changes in the pickup area, such as new vehicles arriving or vehicles leaving after picking up their passengers.

Furthermore, the system may be capable of generating alerts for unauthorized vehicle detection or other security concerns. This could involve flagging vehicles that are not registered in the system's database or detecting unusual behavior in the pickup area. These alerts can be displayed on the operator device 20, allowing the staff member operator to quickly respond appropriately to potential security issues and to be prompted to enter details for an unknown vehicle into the database.

The operator device 20 may typically be implemented as a mobile device capable of wireless communication with the server 26, allowing the staff member operator to move around the pickup area as needed while maintaining full access to the system's interface and functionalities. The wireless capability also provides flexibility in setting up and reconfiguring the system as needed.

For scalability, the system can be easily adapted to handle varying numbers of vehicles and children. The server 26 may be scaled to process larger volumes of data, and additional cameras or sensors can be added to cover larger pickup areas. The software running on the server and operator device may also be updated or modified to accommodate new features or changing requirements.

The automated person pickup system 100 represents a significant improvement over traditional pickup methods in several key areas. It enhances efficiency by automating many of the tasks that would traditionally require manual intervention, such as vehicle identification and queue management. It improves safety by keeping children inside the safety of the facility until needed while also ensuring children are only released to authorized individuals and by providing real-time monitoring of the pickup area. The system also enhances the user experience for both staff members and parents & guardians by providing clear, real-time information about the status of the pickup process.

As such, FIG. 2 depicts a comprehensive and innovative automated person pickup system that addresses the limitations of manual systems while providing a scalable and adaptable solution for various institutional settings. By integrating advanced detection technologies, centralized data processing, and intuitive user interfaces, the system enhances efficiency, safety, and user experience in the person pickup process. This system has the potential to significantly improve pickup processes in a wide range of environments, from schools and daycare centers to large corporate campuses or healthcare facilities. The device(s) used throughout this system can be used to identify unusual or suspicious behavior as well as unknown vehicles, vehicles arriving at unexpected times or in unexpected areas.

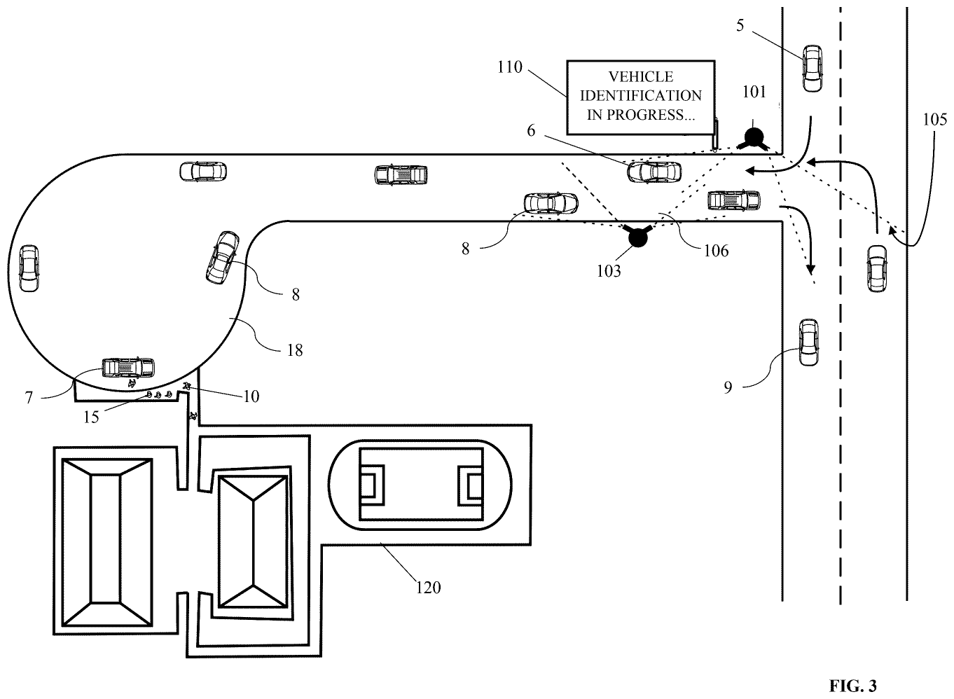

The illustration in FIG. 3 illustrates an exemplary embodiment of the automated person pickup system, showcasing a flow of vehicles through the pickup process at an institution's premises 120, such as a school, hospital, or other venue where persons or children may be picked up. In particular, the diagram depicts exemplary key stages of the pickup process, beginning with the oncoming vehicle 5 shown approaching the identification area, but not yet within the field of view 105 of the entry camera or sensor 101.

Further shown is the vehicle 6 that has entered the identification area and is within the field of view 105 of the entry camera or sensor 101. This camera may be bi-directional, capable of detecting both entry and exit of vehicles. Also shown is vehicle 7, which is positioned in the pickup area 18, currently in the process of picking up a child or person from the queue 15 of children or persons awaiting pickup. On the other hand, the vehicle 8 has completed the pickup and is exiting the pickup area 18, while the vehicle 9 has fully exited the premises and is detected by the exit camera or sensor 103, within its field of view 106.

In this exemplary illustration, a staff member 10 is positioned in the pickup area 18, responsible for overseeing the pickup process. Their duties may include confirming driver identity, reviewing and updating vehicle records, checking for alerts (such as revoked custody, relaying any important notes to the driver, and marking children as picked up in the system via a mobile device. Without limitation, the children or persons being picked up may be queued as in 15, adjacent to the pickup area 18 or located inside the facility for safety, only existing the facility shortly before their designated vehicle arrives in the pickup area 18.

In a further exemplary aspect, it is shown a billboard or digital display 110 placed, preferably showing relevant information such as the current vehicle under identification, the queue order, or the person/child being picked up. This exemplary, non-limiting layout ensures a smooth flow of traffic from entry to exit, with clear delineation of identification and pickup zones. The placement of cameras and sensors (101 and 103) allows for continuous monitoring and data collection throughout the process, feeding real-time information to the central server for processing and queue management.

In various aspects, the placement of cameras and sensors may be specifically angled to view either the front, rear, or both sides of incoming vehicles, ensuring capture of identifying features such as license plates or distinctive vehicle characteristics. The system's image and/or sensor data processing algorithms preferably analyze these captures in real-time, identifying and logging each vehicle as it enters the queue. Further complementing this setup, the non-limiting additional camera may be mounted at the exit point of the pickup area. This exit camera may serve a role in automatically updating the queue by detecting when identified vehicles leave the premises. As a vehicle passes the exit camera, the system cross-references its appearance with the existing queue data, promptly removing the departing vehicle from the active queue. This exemplary dual-camera configuration ensures a comprehensive, automated tracking of vehicles from entry to exit, minimizing manual intervention and enhancing the overall efficiency and accuracy of the pickup process.

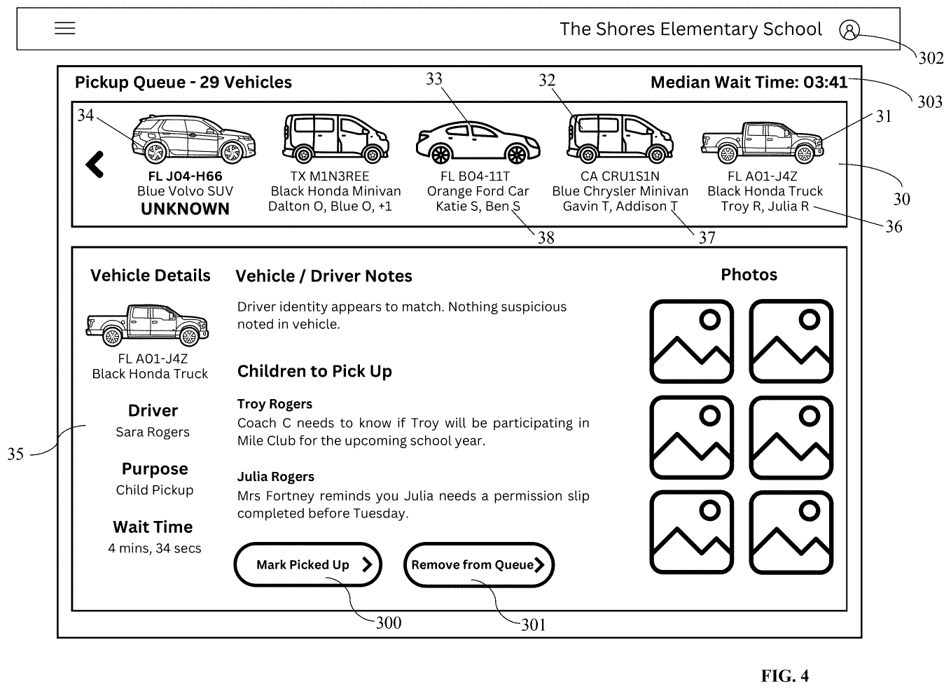

The exemplary embodiment of FIG. 4 provides an illustration of the graphical user interface (GUI) 21, which is a critical component of the automated person pickup system. This interface may be designed to provide staff member operators with a comprehensive, real-time view of the pickup process, enabling efficient management and oversight of vehicle arrivals, insights into identified vehicles, persons to be picked up, and overall queue status. In preferred aspects, the disclosed system provides precise and comprehensive logging capability, by meticulously recording the exact timestamps of events throughout the pickup process, including the moment vehicles enter the facility grounds, the specific time when children are placed into each vehicle (as confirmed by the staff member's interface interaction), and the precise instant when vehicles exit the premises, thereby creating a detailed, time-stamped record that enhances security, enables accurate reporting, facilitates potential dispute resolution, and provides valuable data for optimizing the overall efficiency of the pickup procedure. Optionally, one or more photos or a short video recording the children entering the vehicle in the pickup area 18 may be stored with the record for later access in order to confirm which children entered which vehicles.

The GUI 21 may be divided into several key sections, each serving a specific purpose in the pickup management process. At the top of the interface, it is shown the vehicle registration details in the system 35. This section may display information about newly arrived vehicles or allow staff member operators to input data for vehicles that are not automatically recognized by the system's detection devices. This feature ensures that even in cases where automatic recognition fails, the system can still accommodate and process new arrivals efficiently.

A prominent feature of the GUI is the animated pickup lane 30. This may comprise a dynamic visualization representing the physical pickup area, providing a clear and intuitive representation of the current state of the queue. Within this animated pickup lane, it is shown three animated vehicle icons, each representing a car currently in the pickup process.

The first animated vehicle icon 31 is positioned at the front of the queue, indicating that this vehicle is currently at the pickup point and ready to collect its assigned person. The second animated vehicle icon 32 is shown behind the first, representing the next vehicle in line. The third animated vehicle icon 33 is positioned further back, showing the subsequent vehicle in the queue. In some aspects, these animated icons are not static images but dynamic representations that can move and update in real-time as vehicles progress through the pickup lane.

Preferably, each animated vehicle icon is visually linked to a corresponding set of pickup details displayed on the left side of the interface. The first car pickup details 36 correspond to the vehicle represented by icon 31, providing essential information such as the vehicle's identification (which could be a license plate number or a system-assigned ID), the names of the persons or children to be picked up, authorized person to pick up, and any special instructions or notes relevant to this particular pickup.

Similarly, the second car pickup details 37 and third car pickup details 38 provide analogous information for the vehicles represented by icons 32 and 33, respectively. This side-by-side presentation of the animated queue and detailed pickup information allows staff member operators to quickly associate each vehicle with its corresponding person and any specific requirements or considerations.

The GUI 21 may be designed to be interactive. Staff member operators can likely click on or hover over the animated vehicle icons to bring up additional information or options. For instance, clicking on an icon might allow the staff member operator to mark a pickup as completed, report an issue, or make last-minute changes to the pickup details.

Further, color coding may be used throughout the interface to convey status information at a glance. For example, vehicles where the driver and authorized persons to be picked up is known might be displayed in green, while those with incomplete information or pending issues could be highlighted in yellow or red. This color-based system allows staff member operators to identify at a glance and address any potential problems in the pickup process.

The animated nature of the pickup lane 30 and vehicle icons (31, 32, 33 may serve multiple purposes. Firstly, it may provide a more engaging and intuitive representation of the physical pickup area, making it easier for staff member operators to understand the current state of the queue at a glance. Secondly, the animations may be used to convey additional information, such as a vehicle moving forward in the queue or departing after a successful pickup.

At the interface, there may be additional controls or information displays not explicitly labeled in the figure. These could include options to manually adjust the queue order, broadcast messages through the public address system, or view overall statistics about the day's pickup process.

The GUI 21 may be responsive and adaptable to different screen sizes and orientations. This would allow it to function effectively on various devices, from desktop monitors in a school office to tablets or smartphones that staff members might use while moving around the pickup area.

Therefore, the FIG. 4 illustrates a user-friendly graphical interface that serves as the primary point of interaction between the human operators and the automated person pickup system. By combining dynamic visualizations with detailed information displays, this GUI enables efficient management of the pickup process, enhancing safety, reducing waiting times, and improving the overall experience for both staff member operators and those being picked up. The interface's real-time updating capabilities and intuitive design make it a powerful tool in streamlining what has traditionally been a complex and often chaotic process.

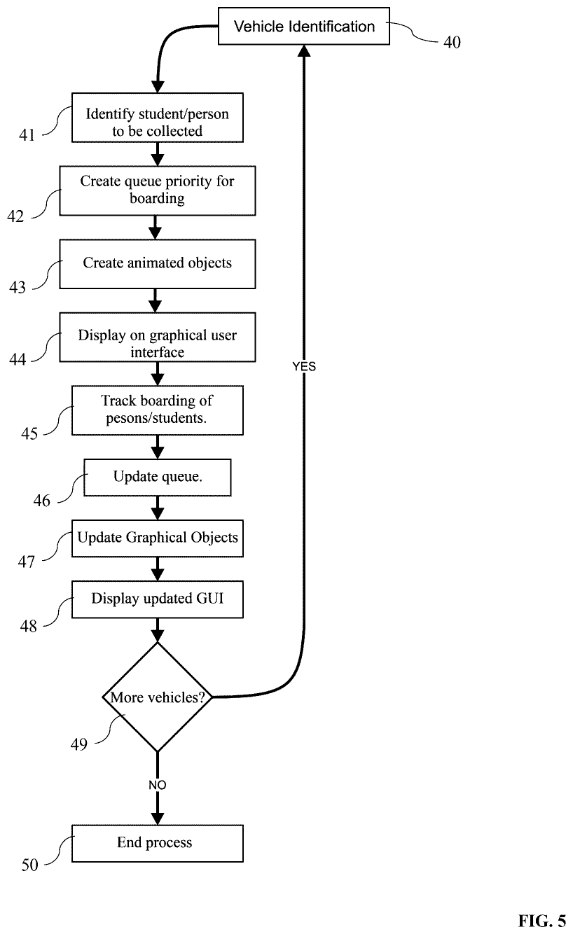

On the other hand, the exemplary embodiment of FIG. 5 is a flow diagram illustrating the process flow for the automated child/person pickup system. This diagram outlines some of the preferred steps and decision points in the pickup process, demonstrating how the system leverages various technologies and components to streamline and secure the child pickup operation.

The process begins with Step 40, the Vehicle Identification. As a vehicle enters the facility, it may be detected by a combination of sensors and cameras strategically placed at the entrance. These may include high-resolution cameras with optical character recognition (OCR) capabilities for license plate reading, RFID sensors for detecting pre-registered tags, and proximity sensors to accurately determine the vehicle's position. The system's central server, equipped with image processing or data processing algorithms and/or machine learning models, analyzes the incoming data to identify the vehicle.

Once the vehicle is identified, the process moves to Step 41 to Identify Student/Person to be Collected. The server preferably accesses a database containing vehicle information linked to authorized pickup individuals and associated students/Persons. This database may be regularly updated and encrypted to ensure data security and accuracy. The system may cross-reference the identified vehicle with the database to determine which person(s) should be picked up.

In the Step 42 the process proceeds to creating Queue Priority for Boarding, the system's queue management algorithm comes into play. This algorithm may consider various factors such as vehicle arrival time, any pre-arranged priority pickups, and the current distribution of students ready for pickup. The algorithm runs on the server, preferably utilizing real-time data to continuously optimize the queue order for maximum efficiency.

In Step 43 the process entails creating Animated Objects, which involves the generation of a visual representation for the identified vehicle. This step is executed on the graphical processing unit of the system, which creates a dynamic, animated icon representing the vehicle. The icon may be designed to reflect key characteristics of the vehicle (e.g., type, make, model, color) and can be easily distinguished on the graphical user interface.

The subsequent Step 44 is to Display on Graphical User Interface the animated object and associated queue information transmitted to the staff member operator's device (which could be a tablet, phone, desktop computer, or specialized hardware). This interface may be designed with user experience in mind, featuring intuitive layouts and touch-screen compatibility for easy interaction.

The Step 45 entails Tracking Boarding of Person/Student, which may involve the real-time monitoring of the pickup process. This could be implemented through various means, such as RFID-enabled student ID cards that register when a student approaches a vehicle, camera systems with AI-powered human detection algorithms, or manual input from supervising staff via the GUI. The chosen method would depend on the specific implementation and privacy considerations of the institution.

As pickups are completed, the system moves to Step 46, Updating Queue. The queue management algorithm re-runs, taking into account the completed pickup and any new arrivals. This ensures that the queue remains optimized throughout the entire pickup process.

The Step 47 entails Updating the Graphical Object, in which the system refreshes the visual representations on the GUI. This involves removing the icon for departed vehicles, moving other icons forward in the queue, and potentially adding new icons for newly arrived vehicles. These updates may be handled by the system's graphical processing unit and pushed to the staff member operator's device in real-time.

In Step 48 is to Display Updated GUI, whereby the refreshed information is presented on the operator interface. This step ensures that the staff member operator always has the current view of the pickup situation, enabling informed decision-making and efficient management of the process.

The Step 49 presents a decision point for determining availability of more vehicles in queue. In this non-limiting example, the system checks if there are more vehicles in the queue or newly arriving. This check is performed by continually monitoring input from the entrance sensors and cameras. If more vehicles are detected, the process loops back to Step 40, restarting the identification process for the next vehicle.

If no more vehicles are detected, the process moves to Step 50, where it ends. This could trigger a series of cleanup operations, such as generating end-of-day reports, securely storing collected data, and potentially initiating system maintenance or update routines.

In various aspects, throughout this entire process, the system relies on network infrastructure for seamless communication between all components—from entrance sensors to the server to staff member operator devices. The system may also incorporate multiple layers of security, including data encryption, secure user authentication, and audit logging, to protect sensitive information and ensure the integrity of the pickup process.

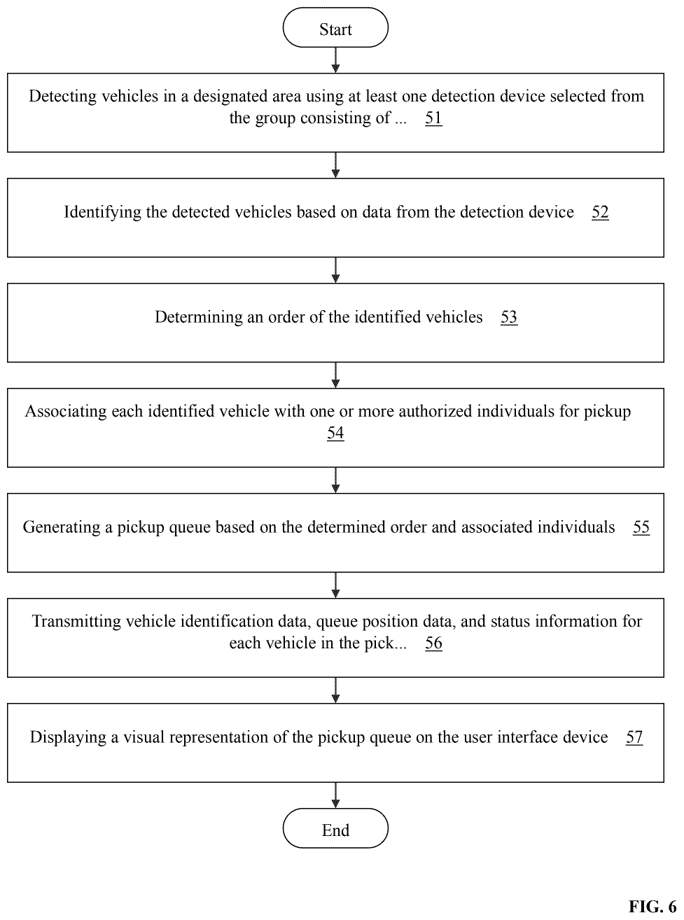

On the other hand, the FIG. 6 is a flowchart that further describes a method for automated person pickup, according to some embodiments of the present disclosure. In some embodiments, a non-transitory computer-readable storage medium. At 51, the method may include detecting vehicles in a designated area using at least one detection device selected from the group consisting of imaging device(s) and proximity sensor(s). At 52, the method may include identifying the detected vehicles based on data from the detection device. At 53, the method may include determining an order of the identified vehicles. At 54, the method may include associating each identified vehicle with one or more authorized individuals for pickup.

In some embodiments, at 55, the method may include generating a pickup queue based on the determined order and associated individuals. At 56, the method may include transmitting vehicle identification data, queue position data, and status information for each vehicle in the pickup queue to a user interface device. At 57, the method may include displaying a visual representation of the pickup queue on the user interface device. Additionally, the method may include communicating pickup instructions as visual representation on the user interface device.

In some embodiments, the server may be further configured to generate alerts for unauthorized vehicle detection or security concerns. In some embodiments, the server may be further configured to transmit vehicle identification data, queue position data, and status information for each vehicle in the pickup queue to the user interface device(s). The user interface device may be further configured to receive the vehicle identification data, queue position data, and status information from the server, generate animated icons representing the identified vehicles based on the received data, create a visual representation of the pickup queue using the generated animated icons, display the visual representation of the pickup queue on the user interface device, update the animated icons in real-time based on subsequent data received from the server to reflect the current status and position of each vehicle in the queue.

In some embodiments, identifying the detected vehicles comprises using optical character recognition to read license plates of the vehicles. In some embodiments, associating each identified vehicle with one or more authorized individuals comprises accessing a database storing vehicle information and associated authorized individual information. In some embodiments, the method may include communicating pickup instructions audibly through a public address system in addition to the visual representation on the user interface device.

While the descriptions and figures showcase a specific configuration of cameras and sensors for detecting and identifying vehicles, a variety of additional or alternative detection technologies may be incorporated in embodiments for this purpose without departing from the spirit of the automated person pickup system concepts. Other vehicle detection and identification options applicable to the system include, but are not limited to, RFID tag readers, GPS tracking integration, Bluetooth Low Energy (BLE) beacons, computer vision with deep learning for vehicle make and model recognition, LiDAR for 3D mapping of the pickup area, millimeter-wave radar for precise vehicle positioning, and other demonstrated methods that provide reliable detection and identification. These allow the server to derive accurate vehicle information and positioning data through various means, whether based on electromagnetic, optical, acoustic, or other properties amenable to outdoor installation, durability, and computational interpretation.

Therefore, it is expressly disclosed that in addition to or even in place of the example detection techniques mentioned in the claims, alternative detection technologies may be integrated into the automated person pickup system to achieve the same ends of registering vehicle presence, identity, visual description, and position related to the pickup process. Such implementable alternatives, expressly disclosed as functionally equivalent options fully available for integration in the present automated person pickup systems without limitation, include but are not limited to the aforementioned detection means.

Use of these equivalent options for instrumented detection presents equal derivative claim standing per the linked vehicle detection objectives and system utility improvements disclosed, regardless of the specific technique elected for implementation in the automated person pickup system.

### INDUSTRIAL APPLICATION

The invention described herein finds significant industrial application beyond educational institutions. It can be implemented in large corporate campuses to manage employee transportation and carpooling, enhancing workplace efficiency and reducing traffic congestion. In healthcare settings, it can streamline patient discharge processes, improving hospital throughput and patient satisfaction. The system is also applicable in transportation hubs like airports or train stations, managing taxi, personal vehicle, and rideshare queues more effectively. Additionally, it can be adapted for use in manufacturing facilities to coordinate shift changes and employee pickup/drop-off, or in event management to organize attendee departures from large venues. Its flexibility and scalability make it valuable across various industries requiring organized pickup of persons.

What is claimed is:

1. An automated person pickup system comprising:
at least one detection device selected from the group comprising of imaging devices and proximity sensors, configured to detect vehicles in a designated area;
a server coupled to the detection device, the server comprising a processor and a memory storing instructions that, when executed by the processor, cause the system to:
i. identify vehicles based on data from the detection device(s);
ii. determine an order of the identified vehicles;
iii. associate each identified vehicle with one or more persons for pickup;
iv. generate a pickup queue based on the determined order and associated individuals;
a user interface device coupled to the server and configured to display the pickup queue and receive user input; and
an output device coupled to the server and configured to communicate pickup instructions.

2. The system of claim 1, wherein the detection device is an imaging device comprising a camera with optical character recognition capabilities for reading license plates.

3. The system of claim 1, wherein the detection device is a proximity sensor configured to detect the presence and location of vehicles in the designated area.

4. The system of claim 1, further comprising a database storing vehicle information and associated information about the driver and persons to be picked up, wherein the server is configured to access the database to associate identified vehicles with one or more persons to be picked up.

5. The system of claim 1, wherein the user interface device is a mobile device capable of wireless communication with the server.

6. The system of claim 1, wherein the output device is a public address system configured to announce pickup instructions audibly.

7. The system of claim 1, wherein the server is further configured to update the pickup queue in real-time based on vehicle arrivals and departures detected by the detection device(s).

8. The system of claim 1, wherein the server is further configured to generate alerts for unauthorized vehicle detection or security concerns.

9. The system of claim 1, wherein:
i. the server is further configured to:
i. transmit vehicle identification data, queue position data, and status information for each vehicle in the pickup queue to the user interface device;
ii. the user interface device is further configured to:
i. receive the vehicle identification data, queue position data, and status information from the server;
ii. generate animated icons representing the identified vehicles based on the received data;
iii. create a visual representation of the pickup queue using the generated animated icons;
iv. display the visual representation of the pickup queue on the user interface device; and
v. update the animated icons in real-time based on subsequent data received from the server to reflect the current status and position of each vehicle in the queue.

10. A method for automated person pickup, comprising:
i. detecting vehicles in a designated area using at least one detection device selected from the group comprising of imaging device(s) and a proximity sensor(s);
ii. identifying the detected vehicles based on data from the detection device(s);
iii. determining an order of the identified vehicles;
iv. associating each identified vehicle with one or more authorized persons for pickup;
v. generating a pickup queue based on the determined order and associated individuals;
vi. transmitting vehicle identification data, queue position data, and status information for each vehicle in the pickup queue to a user interface device;
vii. displaying a visual representation of the pickup queue on the user interface device; and
viii. communicating pickup instructions as visual representation on the user interface device.

11. The method of claim 1, wherein identifying the detected vehicles comprises using optical character recognition to read license plates of the vehicles.

12. The method of claim 1, wherein detecting vehicles comprises sensing the presence and location of vehicles using a proximity sensor.

13. The method of claim 1, wherein associating each identified vehicle with one or more authorized persons to be picked up comprises accessing a database storing vehicle information and associated authorized individual information.

14. The method of claim 1, wherein displaying the visual representation of the pickup queue comprises:
i. generating animated icons representing the identified vehicles based on the received vehicle identification data, queue position data, and status information;
ii. creating the visual representation of the pickup queue using the generated animated icons; and
iii. updating the animated icons in real-time based on subsequently received data to reflect the current status and position of each vehicle in the queue.

15. The method of claim 1, wherein communicating pickup instructions comprises announcing the instructions audibly through a public address system.

16. A non-transitory computer-readable storage medium having computer-executable instructions stored thereon that, when executed by one or more processors, cause the one or more processors to perform a method for automated person pickup, the method comprising:
i. detecting vehicles in a designated area using at least one detection device selected from the group comprising of an imaging device and a proximity sensor;
ii. identifying the detected vehicles based on data from the detection device;
iii. determining an order of the identified vehicles;
iv. associating each identified vehicle with one or more authorized persons for pickup;
v. generating a pickup queue based on the determined order and associated individuals;
vi. transmitting vehicle identification data, queue position data, and status information for each vehicle in the pickup queue to a user interface device;
vii. displaying a visual representation of the pickup queue on the user interface device; and
viii. communicating pickup instructions as visual representation on the user interface device.

17. The non-transitory computer-readable storage medium of claim 16, wherein identifying the detected vehicles comprises using optical character recognition to read license plates of the vehicles.

18. The non-transitory computer-readable storage medium of claim 16, wherein associating each identified vehicle with one or more authorized persons for pickup comprises accessing a database storing vehicle information and associated authorized individual information.

19. The non-transitory computer-readable storage medium of claim 16, wherein displaying the visual representation of the pickup queue comprises:
i. generating animated icons representing the identified vehicles based on the received vehicle identification data, queue position data, and status information;
ii. creating the visual representation of the pickup queue using the generated animated icons; and
iii. updating the animated icons in real-time based on subsequently received data to reflect the current status and position of each vehicle in the queue.

20. The non-transitory computer-readable storage medium of claim 16, wherein the method further comprises communicating pickup instructions audibly through a public address system in addition to the visual representation on the user interface device.
